(19) United States
(12) Patent Application Publication
(10) Pub. No.: US 2012/0044686 A1
(43) Pub. Date: Feb. 23, 2012

(54) LED light strip

(76) Inventors: Chien Ching Yang, Yingge Township (TW); Hai Yang Deng, Yuiyang Dist (CN)

(21) Appl. No.: 12/858,491

(22) Filed: Aug. 18, 2010

(51) Int. Cl. F21S 4/00

(52) U.S. Cl. 362/249.02

(57) ABSTRACT

A LED light strip having a narrow elongated base layer prepared from flexible heat-resisting polyethylene terephthalate, two narrow elongated conducting copper layers coated on the base layer and arranged in a parallel manner along the length of the base layer, a cover layer prepared from flexible heat-resisting polyethylene terephthalate and covered on the base layer over the conducting layers, a plurality of crevices cut through the cover layer and spaced along the length of the cover layer and a plurality of surface mount device light-emitting diodes bonded to the conducting layers in the transverse crevices.

### BACKGROUND OF THE INVENTION

1. Field of the Invention

The present invention relates to KED light technology and more particularly, to a LED light strip, which facilitates installation of LEDs and gives protection to the installed LEDs against accidental scratch.

2. Description of the Related Art

A regular LED light strip is known comprising a narrow elongated circuit board prepared from a hard or flexible substrate, and a plurality of LEDs bonded to the circuits on the circuit board and spaced along its length. Because the LEDs are exposed to the outside of the circuit board, they tend to be biased, scratched or damaged accidentally. Therefore, the yield rate of the fabrication of this conventional design is low.

Therefore, it is desirable to provide a LED light strip, which eliminates the aforesaid problems.

### SUMMARY OF THE INVENTION

The present invention has been accomplished under the circumstances in view. It is the main object of the present invention to provide a LED light strip, which facilitates installation of LEDs and gives protection to the installed LEDs against accidental scratch.

To achieve this and other objects of the present invention, a LED light strip comprises a narrow elongated base layer prepared from a flexible heat-resisting material, two narrow elongated conducting layers coated on the base layer and arranged in a parallel manner along the length of the base layer, a cover layer prepared from a flexible heat-resisting material and covered on the base layer over said conducting layers, a plurality of crevices cut through the cover layer and spaced along the length of the cover layer and a plurality of surface mount device light-emitting diodes bonded to the conducting layers in said transverse crevices.

Further, the crevices vertically extend through the height of the cover layer to let the conducting layers be exposed to the outside for the mounting of the surface mount device light-emitting diodes.

Further, the conducting layers each have two distal ends thereof respectively extending out of the opposing ends of the base layer and the opposing ends of the cover layer for the connection of external LED light strips.

### BRIEF DESCRIPTION OF THE DRAWINGS

FIG. 1 is a top view of a LED light strip in accordance with the present invention (the cover layer excluded).

FIG. 2 is a sectional side view of the LED light strip in accordance with the present invention.

### DETAILED DESCRIPTION OF THE PREFERRED EMBODIMENT

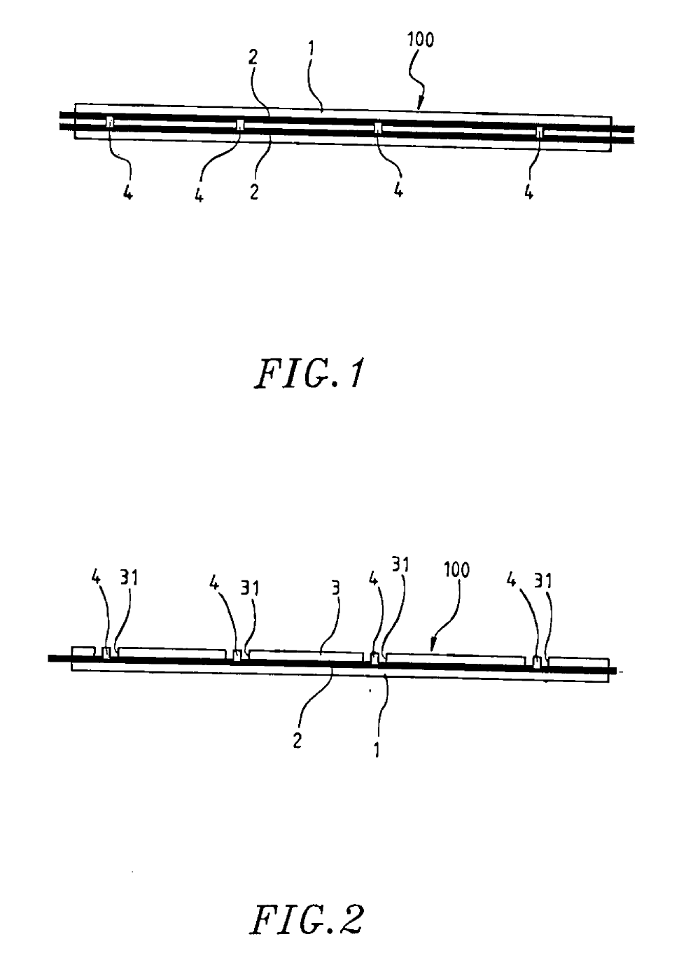

Referring to FIGS. 1 and 2, a LED light strip 100 in accordance with the present invention is shown comprising a narrow elongated base layer 1, two narrow elongated conducting layers 2 coated on the base layer 1 and arranged in a parallel manner along the length of the base layer 1, and a cover layer 3 coated on the base layer 1 over the conducting layers 2.

The narrow elongated base layer 1 is prepared from heat resistant, flexible PET (polyethylene terephthalate). The conducting layers 2 are prepared from copper. The cover layer 3 is prepared from heat resistant, flexible PET (polyethylene terephthalate). Further, the cover layer 3 has a plurality of transverse crevices 31 vertically cut through the height and spaced along the length thereof where the conducting layers 2 are exposed to the outside. Further, SMD LEDs (surface mount device light-emitting diodes) 4 are bonded to the conducting layers 2 in the transverse crevices 31.

Subject to the aforesaid design, the installation of the LED light strip 100 is quite simple. Further, the cover layer 3 protects the SMD LEDs (surface mount device light-emitting diodes) 4 against scratch.

Because the transverse crevices 31 vertically cut through the height of the cover layer 3, the conducting layers 2 can be bonded to the conducting layers 2 in the transverse crevices 31 conveniently. Further, the two distal ends of each of the two narrow elongated conducting layers 2 respectively extending out of the opposing distal ends of the base layer 1 and cover layer 3 of the LED light strip 100 for connection to other LED light strips or power supply circuit means (not shown).

Referring to FIG. 2 again, after bonding of the MD LEDs (surface mount device light-emitting diodes) 4 to the conducting layers 2 in the transverse crevices 31, the MD LEDs (surface mount device light-emitting diodes) 4 are kept in flush with or slightly lower than the outer surface of the cover layer 3 so that the cover layer 3 can well protect the MD LEDs (surface mount device light-emitting diodes) 4 against accidental compact or scratch.

In conclusion, the invention provides a LED light strip having a narrow elongated base layer, two narrow elongated conducting layers coated on the base layer and arranged in a parallel manner along the length of the base layer, a cover layer coated on the base layer over the conducting layers, a plurality of crevices cut through the cover layer and spaced along the length of the cover layer and a plurality of MD LEDs (surface mount device light-emitting diodes) bonded to the conducting layers in the transverse crevices.

Although a particular embodiment of the invention has been described in detail for purposes of illustration, various modifications and enhancements may he made without departing from the spirit and scope of the invention.

What the invention claimed is:

1. A LED light strip, comprising a narrow elongated base layer prepared from a flexible heat-resisting material, two narrow elongated conducting layers coated on said base layer and arranged in a parallel manner along the length of said base layer, a cover layer prepared from a flexible heat-resisting material and covered on said base layer over said conducting layers, a plurality of crevices cut through said cover layer and spaced along the length of said cover layer and a plurality of surface mount device light-emitting diodes bonded to said conducting layers in said transverse crevices.

2. The LED light strip as claimed in claim 1, wherein said crevices vertically extend through the height of said cover layer to let said conducting layers be exposed to the outside for the mounting of said surface mount device light-emitting diodes.

3. The LED light strip as claimed in claim 1, wherein said conducting layers each have two distal ends thereof respectively extending out of opposing ends of said base layer and said cover layer for the connection of external LED light strips.
